(19) United States
(12) Patent Application Publication
(10) Pub. No.: US 2014/0222216 A1
(43) Pub. Date: Aug. 7, 2014

(54) Wireless HVAC Vent

(71) Applicant: Yuyu Chen, Foster City, CA (US)

(72) Inventor: Yuyu Chen, Foster City, CA (US)

(73) Assignee: E3CONTROL, INC.

(21) Appl. No.: 13/815,188

(22) Filed: Feb. 7, 2013

(51) Int. Cl. G05D 7/06

(52) U.S. Cl. CPC G05D 7/0617
USPC 700/276

(57) ABSTRACT

A self-contained wireless HVAC vent which can be independently controlled via a wireless communication link. The HVAC vent is capable of regulating the airflow in to a zone by using adjustable damper(s). The control settings of the HVAC can be configured in conjunction with an application and user interface (UI) via an external device. The HVAC vent also monitors the condition of the air, which may include temperature, air quality and humidity, as well as the presence of potential hazardous conditions. Lastly, the power needed to operate the HVAC vent is acquired from the environmental surrounding and converted and regulated to electrical energy.

### FIELD OF THE INVENTION

The present invention relates to an HVAC vent system and method for regulating airflow from an HVAC unit to a zone in a home or commercial structure. The HVAC vent is also capable of sensing and monitoring the condition of the current air condition.

### BACKGROUND OF THE INVENTION

Most heating, ventilation and air conditioning (HVAC) systems used in residential and small commercial applications employ a centrally located HVAC unit, which is controlled by a single thermostat. The desired temperature is set via the thermostat, which is used to control the operation of the HVAC unit. The output of the HVAC unit is delivered to HVAC vents located throughout various locations rooms and zones of the building.

There are a number of disadvantages to this widely deployed system. Two main disadvantages include 1) reduced comfort and/or increased inconvenience of building occupants, or 2) inefficient energy usage, increasing operating costs and environmental impact.

As these systems employ a single thermostat, all of the zones serviced by the HVAC unit share the same temperature setting. What may be a comfortable temperature from one inhabitant may not be for other inhabitants. Furthermore, since the HVAC unit is controlled by the temperature measured at the location of thermostat, the operation of the HVAC unit is controller based on the temperature measured at a single point. Due to many factures, including the construction of the building and the fact that hot air rises, the actual temperature at different sections of the building serviced by the HVAC unit may vary widely. This results in some zones being too hot while others being too cold.

Prior art HVAC systems not only provide sub-optimal comfort, but result in higher operating cost and energy waste. More importantly than the financial costs, energy waste creates an unnecessary environmental impact. Heating and/or cooling uninhabited rooms and zones results in unnecessary energy consumption

Prior art manually adjusted HVAC vents have not proved to be effective in addressing occupant comfort and energy waste.

Zoned HVAC systems are common in commercial structures, and zoned systems have been making inroads into the home market. In a zoned system, sensors in each room or group of rooms, or zones, monitor the temperature. The sensors can detect where and when heated or cooled air is needed. The sensors send information to a central controller that activates the zoning system, adjusting motorized dampers built in to the ductwork and sending conditioned air only to the zone in which it is needed. A zoned system adapts to changing conditions in one area without affecting other areas.

A zoned system allows more control over the indoor environment because occupants can select different operating conditions for each zone. This includes not only different temperature settings, but may set times of the day to remain inactive. Unfortunately, zoned HVAC systems are expensive to purchase and install, and complicated to configure and maintain. The cost and complexity of zoned HVAC systems are major barriers to their widespread deployment.

### SUMMARY

The system and method disclosed herein addresses the shortcomings of prior art HVAC systems by describing a self-contained wireless HVAC vent. The wireless HVAC vent enables zoned HVAC capabilities for systems serviced by a centrally located HVAC unit. Furthermore, the wireless HVAC vent is designed to directly replace manually operated HVAC vents without requiring additional wiring or installation procedures. The wireless HVAC vent is a self-contained units and contains the following capabilities, 1) wireless communication, 2) control and sensing, 3) air damper motor control and drive, 4) power conversion and battery management. The wireless HVAC vent allows the operating condition of each zone to be controlled independently.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates an embodiment example of a wireless HVAC vent.

### DETAILED DESCRIPTION OF INVENTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention. Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The system and method disclosed herein addresses the shortcomings of prior art HVAC systems by describing a self-contained wireless HVAC vent. The wireless HVAC vent enables zoned HVAC capabilities for systems serviced by a centrally located HVAC unit. Furthermore, the wireless HVAC vent is designed to directly replace manually operated HVAC vents without requiring additional wiring or installation procedures. The wireless HVAC vent is a self-contained units and contains the following capabilities, 1) wireless communication, 2) control and sensing, 3) air damper motor control and drive, 4) power conversion and battery management. The wireless HVAC vent allows the operating condition of each zone to be controlled independently.

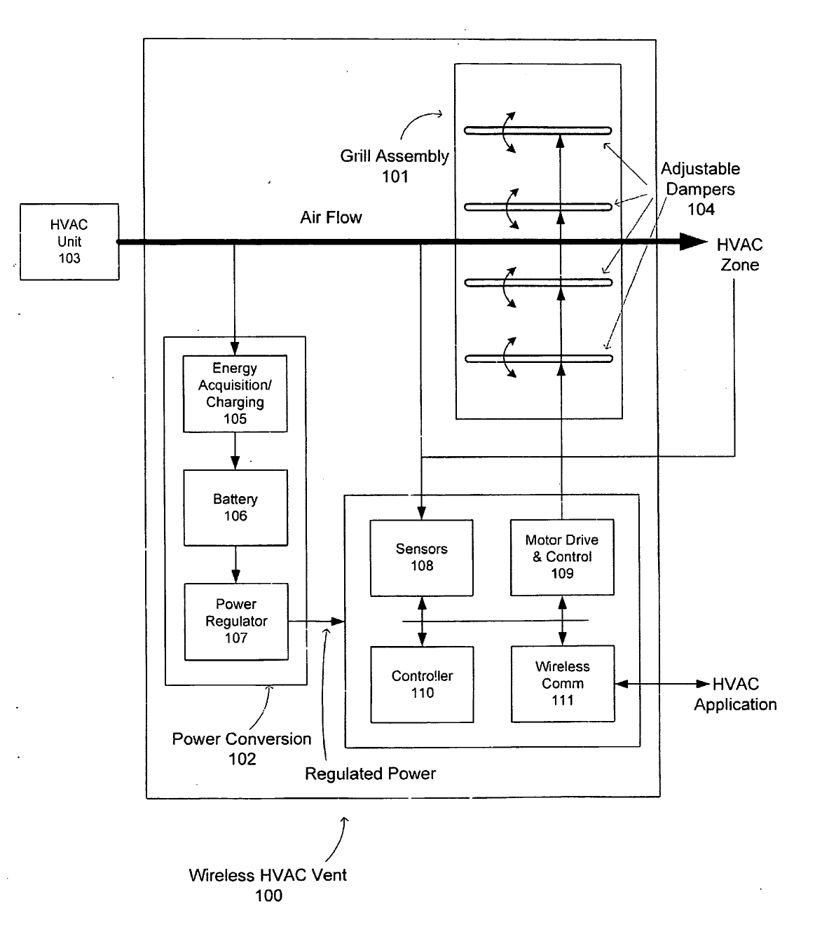

FIG. 1 illustrates a block diagram of one embodiment the wireless HVAC vent per the present invention. Wireless HVAC vent 100 contains damper assembly 101 which used to regulate the air flow from HVAC unit 103 to the HVAC zone it services by using one or more adjustable dampers 104. The position of adjustable damper(s) 104 is adjusted by motor control and drive 109. Adjustable damper(s) 104 may also be directly adjusted manually. The specific position of adjustable damper(s) 104 is determined by controller 110. Controller 110 determines the desired position of adjustable damper(s) 104. Non limiting examples of factors used by controller 110 to determine the position of adjustable damper(s) 104 are, detected temperature of air output from HVAC unit 103, detected temperature of air in the HVAC zone, and temperature setting from HVAC application. Monitoring the air temperature is accomplished by sensors 108. Sensors 108 may also be capable of detecting addition conditions such as air pressure, air quality, and presence of hazardous conditions. Controller 110 will adjust the position of adjustable damper(s) 104 via motor control and drive 109 based on changing conditions and by changes in the settings as defined by the HVAC application. Controller 110 is capable of reporting self-diagnostic data as well as data of the surrounding environment to the HVAC application as well as transmits alerts when a hazardous condition is detected. Communication with the wireless HVAC vent and the HVAC application is provided by wireless communication module 111. Wireless communication module 111 provides wireless communications using a number of available technologies, including but not limited to Zigbee, Wi-Fi. The HVAC application may be available via a terminal on a local wireless network or have access to the Internet via a wireless gateway device. Examples of a terminal device include an iPad/iPhone running an iOS (Apple, Inc.) HVAC application, Android tablet running an Android based HVAC application (Google, Inc.), or personal computing (PC) device running a Windows (Microsoft, Inc.) based HVAC application. The wireless HVAC vent may also have direct communication with the central thermostat or indirect communication via the HVAC application.

As mentioned about, wireless HVAC vent 100 of the present invention is fully self- contained and can be used to directly replace non-automated HVAC vents without requiring additional installation requirements such as connection to a power source. Furthermore, wireless HVAC vent 100 does not require maintenance, including the replacement of batteries. Again referring to FIG. 1, power conversion module 102 includes energy acquisition and charging module 105. Energy acquisition and charging module 105 converts mechanical energy to electrical energy. One non-limiting example is energy acquisition and charging module 105 employs a windmill device that converts the mechanical energy created when the air flowing through wireless HVAC vent 100 to the HVAC zone turns the wind turbine of the windmill device. The unregulated electrical energy acquired by the windmill device is used to charge battery 106. Another non- limiting example of mechanical energy harvested by energy acquisition and charging module 105 is created by air pressure created while HVAC unit 103 is operation. This is especially useful when the adjustable damper(s) 104 are in the closed position. The charge status of battery 106 may be monitored by the HVAC application. Under low battery conditions, the HVAC may initiate air flow from the HVAC unit in order to recharge to battery 106 to an acceptable level. Power regulator 107 provides regulated output(s) necessary to power the other components of the wireless HVAC vent 100.

As mentioned, sensors 108 are capable of detecting temperature levels of the air provided by HVAC unit 103 and of the HVAC zone. However, sensors 108 may also detect additional environmental conditions. Based on detected parameters, the HVAC applications may define operation of wireless HVAC vent 100. Non-limiting examples include barometric pressure, presence hazardous materials or gases, and presence of fire or smoke. For example, if a fire is detected, the wireless HVAC vent may he preprogrammed to place the adjustable damper(s) 104 in the closed position as well as send an alert to the HVAC application via wireless module 111.

What is claimed

1. A wireless HVAC vent system for selectively controlling air flow from at least one efferent end of the ducts of an HVAC unit, comprising:
a damper assembly to control the flow of air from the HVAC unit to a zone in response to flow control signals;
a controller device for generating flow control commands and setting the position of the damper assembly;
a wireless communications transceiver providing communication between the wireless HVAC vent and an HVAC application; and a a power conversion unit comprising:
a battery for providing operating energy to the wireless HVAC system,
a power regulator which provides regulated outputs to the HVAC system components, and
an energy acquisition system which converts non-electrical energy in to electrical energy, and,
a battery charging circuit to recharge the battery.
